(19) United States
(12) Patent Application Publication
(10) Pub. No.: US 2008/0282974 A1
(43) Pub. Date: Nov. 20, 2008

(54) Liquid curing apparatus for liquid transfer device

(75) Inventor: Toshiharu Takemata, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 12/150,664

(22) Filed: Apr. 30, 2008

(30) Foreign Application Priority Data
May 15, 2007 (JP) 129010/2007

(51) Int. Cl. B05C 9/08

(52) U.S. Cl. 118/620

(57) ABSTRACT

A liquid curing apparatus for a liquid transfer device includes a liquid transfer unit and a plurality of ultraviolet-emitting diodes. The liquid transfer unit transfers an ultraviolet curing liquid to a transfer target body. The plurality of ultraviolet-emitting diodes are arranged to oppose the transfer target body and emit only ultraviolet-wavelength light to irradiate the transfer target body to which the liquid has been transferred by the liquid transfer unit, thereby curing the transferred liquid.

### BACKGROUND OF THE INVENTION

The present invention relates to a liquid curing apparatus for a liquid transfer device comprising a drying device which dries an ultraviolet curing transfer liquid (ink/varnish) or a cold stamping adhesive by irradiation with ultraviolet rays.

In general, a printing press serving as a liquid transfer device comprises a feed device which feeds sheets one by one, a printing unit which prints a sheet fed to it, and an ultraviolet-emitting device which dries ultraviolet curing ink (to be merely referred to as UV ink hereinafter) supplied to the sheet at the printing unit by irradiation with ultraviolet rays. In a conventional ultraviolet-emitting device, as described in Japanese Patent Laid-Open No. 54-123305, a sheet is irradiated with light from a plurality of mercury lamps, so that the sheet absorbs the ultraviolet rays contained in the radiation light, thus curing and drying the UV ink.

The radiation light emitted from the mercury lamp employed in the conventional ultraviolet-emitting device described above contains infrared rays as well as ultraviolet rays, as described in “Ultraviolet (UV) Curing Screen Ink (reference manual)”, TOYO INK, p. 6, August 2001. Heat of infrared rays generated by the mercury lamp may deform a printing product, particularly a printing product such as a film.

In order to solve this problem, a cooling device to cool the generated heat must be provided. In this case, a space to install the cooling device must be ensured, and the manufacturing cost increases. The mercury lamp generates ultraviolet rays with generation efficiency of comparatively as low as about 20% to 25%. Hence, to dry the UV ink, a large quantity of power must be supplied to the mercury lamp.

### SUMMARY OF THE INVENTION

It is an object of the present invention to provide a liquid curing apparatus for a liquid transfer device which requires a smaller space, a lower cost, and lower power.

In order to achieve the above object, according to the present invention, there is provided a liquid curing apparatus for a liquid transfer device, comprising a liquid transfer unit which transfers an ultraviolet curing liquid to a transfer target body, and a plurality of ultraviolet-emitting diodes which are arranged to oppose the transfer target body and emit only ultraviolet-wavelength light to irradiate the transfer target body to which the liquid has been transferred by the liquid transfer unit, thereby curing the transferred liquid.

### BRIEF DESCRIPTION OF THE DRAWINGS

FIG. 1 is a side view of a sheet-fed rotary printing press as a liquid transfer device according to the first embodiment of the present invention;

FIG. 2A shows the layout of ultraviolet-emitting diodes which constitute a drying device shown in FIG. 1;

FIG. 2B shows the layout of the ultraviolet-emitting diode blocks;

FIG. 3 is a graph of the ultraviolet-emitting diodes shown in FIG. 2A;

FIG. 4 is a block diagram showing the electrical configuration of the sheet-fed rotary printing press shown in FIG. 1;

FIGS. 5A to 5C are flowcharts for explaining the setting operation of the drying device of a CPU shown in FIG. 4 in accordance with the sheet size;

FIG. 6 is a side view of a sheet-fed rotary printing press according to the second embodiment of the present invention;

FIG. 7 is a side view of a sheet-fed rotary printing press according to the third embodiment of the present invention;

FIG. 8 is a side view of a sheet-fed rotary printing press according to the fourth embodiment of the present invention;

FIG. 9 is a side view of a cold stamping device according to the fifth embodiment of the present invention;

FIG. 10 is a view showing the first modification of the layout of the ultraviolet-emitting diodes shown in FIG. 2A; and

FIG. 11 is a view showing the second modification of the layout of the ultraviolet-emitting diodes shown in FIG. 2A.

### DESCRIPTION OF THE PREFERRED EMBODIMENTS

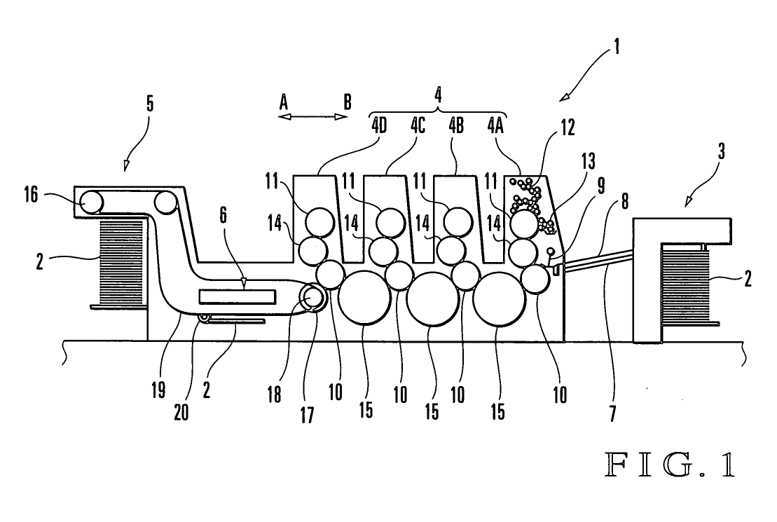

A liquid curing apparatus for a liquid transfer device according to the first embodiment of the present invention will be described with reference to FIGS. 1 to 5C.

As shown in FIG. 1, a sheet-fed rotary printing press 1 serving as a liquid transfer device comprises a feed device 3 which feeds printing sheets 2 as transfer target bodies one by one, a printing unit 4 comprising four printing units 4A to 4D each of which prints the printing sheet 2 fed from the feed device 3 using UV ink as an ultraviolet curing liquid, a delivery device 5 which delivers the printing sheet 2 printed by the printing unit 4, and a drying device 6 arranged between the printing unit 4 and delivery device 5.

Each of the printing units 4A to 4D comprises a plate cylinder 11 on which a plate is mounted, an inking device 12 which supplies the UV ink to the plate, a dampening unit 13 which supplies water to the plate, a blanket cylinder 14 to which an image formed on the plate is transferred by transferring the UV ink and water, and an impression cylinder 10 which tightly urges the printing sheet 2 passing between the impression cylinder 10 and the blanket cylinder 14 against the blanket cylinder 14 to print the image. A belt 8 conveys each of the printing sheets 2, fed from the feed device 3 one by one, on a feedboard 7. A swing arm shaft pregripper 9 then transfers the printing sheet 2 to the impression cylinder 10 of the first-color printing unit 4A.

FIG. 1 shows the inking device 12 and dampening unit 13 of only the first-color printing unit 4A, and does not show those of the remaining printing units 4B to 4D.

Transfer cylinders 15 are disposed among the adjacent impression cylinders 10 of the adjacent the printing units 4A to 4D. The delivery frame of the delivery device 5 rotatably supports a sprocket 16. A sprocket 18 is provided to be coaxial with a delivery cylinder 17 which is in contact with the impression cylinder 10 of the fourth-color printing unit 4D. A pair of delivery chains 19 are looped between the sprockets 16 and 18. Grippers 20 which grip the leading edge of the printed printing sheet 2 are attached to the delivery chains 19 at predetermined intervals. The delivery chains 19 traveling in the direction of an arrow A in FIG. 1 convey the printing sheet 2 gripped by the grippers 20 to the delivery device 5.

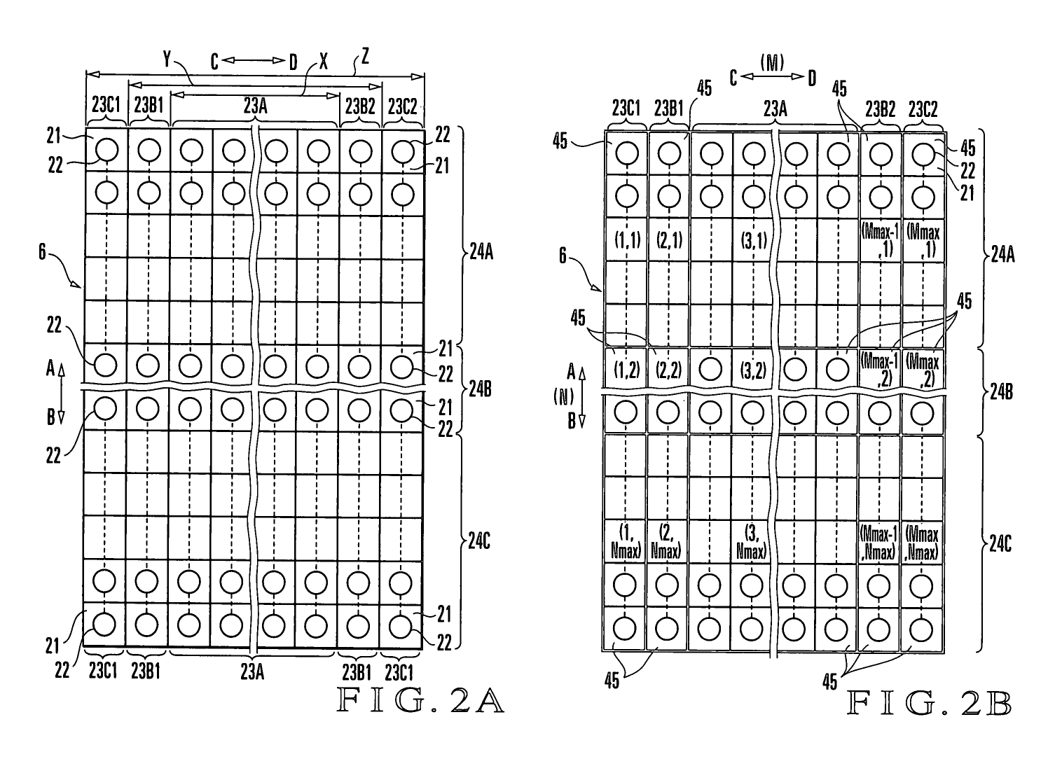

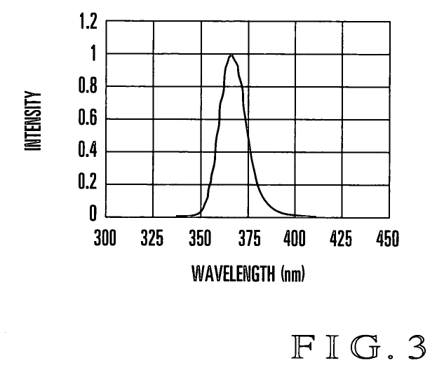

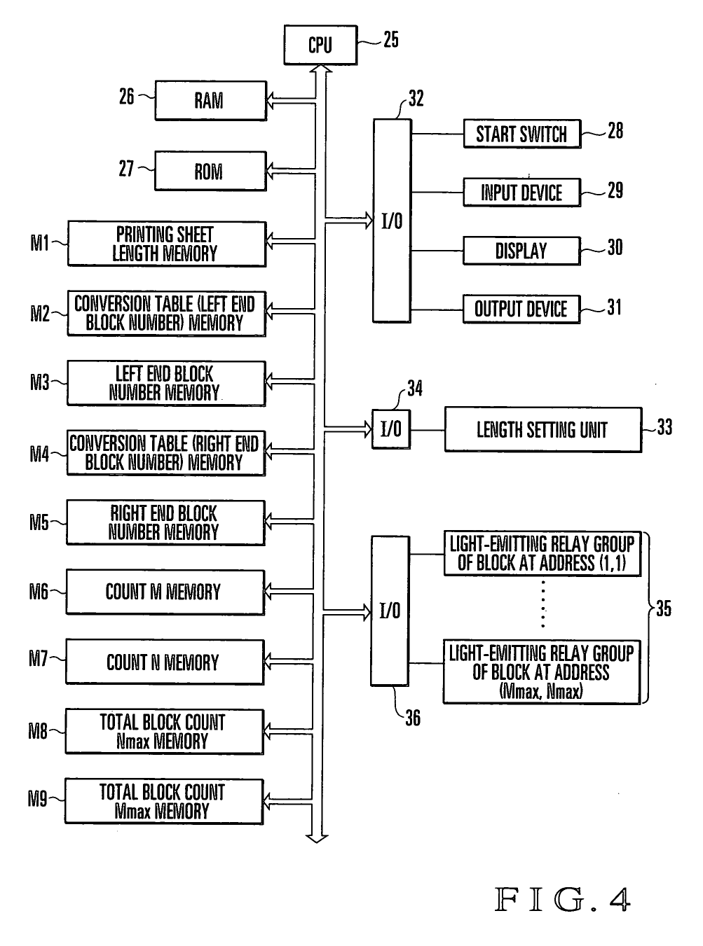

As shown in FIG. 2A, the drying device 6 comprises a plurality of square frames 21 in the convey direction (directions of the arrow A and an arrow B) of the printing sheet and the widthwise direction (directions of arrows C and D) of the printing sheet to form a grid. A plurality of ultraviolet-emitting diodes (to be referred to as light-emitting diodes hereinafter) 22 are respectively loaded in all the frames 21 to oppose the surface of the printing sheet. As shown in FIG. 3, the light-emitting diodes 22 do not emit light other than ultraviolet-wavelength light, and emits only ultraviolet rays having wavelengths within the band of 350 nm to 400 nm. The ultraviolet curing liquid formed of ink/varnish which is transferred to the printing sheet is cured upon irradiation with ultraviolet rays from the light-emitting diodes.

The plurality of light-emitting diodes 22 are arranged in blocks to match the sizes of the printing sheets 2 in the widthwise direction (the directions of the arrows C and D), that is, to match a minimum size X, medium size Y, and maximum size Z. If the sheet is of the minimum size X, a block 23A including the diodes 22 corresponding to the third columns from the two sides and columns inside the third columns is selected. As will be described later, when printing the sheet of the minimum size X, the light-emitting diodes 22 included in the block 23A are selectively turned on in accordance with the length of the printing sheet 2 in the convey direction.

If the sheet is of the medium size Y, the block 23A described above, and blocks 23B1 and 23B2 including the light-emitting diodes 22 corresponding to the second columns from the two sides are selected. When printing the sheet of the medium size Y, the light-emitting diodes 22 included in the blocks 23A, 23B1, and 23B2 are selectively turned on in accordance with the length of the printing sheet 2 in the convey direction.

If the sheet is of the maximum size Z, the blocks 23A, 23B1, and 23B2 described above, and blocks 23C1 and 23C2 including the light-emitting diodes 22 corresponding to the first columns from the two sides are selected. When printing the sheet of the maximum size Z, the light-emitting diodes 22 included in the blocks 23A, 23B1, 23B2, 23C1, and 23C2 are selectively turned on in accordance with the length of the printing sheet 2 in the convey direction.

The light-emitting diodes 22 are blocked also to match the size of the printing sheet 2 in the convey direction (directions of the arrows A and B). If the sheet is of a shortest size, the light-emitting diodes 22 included in a block 24A are selected. If the sheet is of a medium size, the light-emitting diodes 22 included in the block 24A and a block 24B are selected. If the sheet is of a longest size, the light-emitting diodes 22 included in the blocks 24A and 24B and a block 24C are selected.

A plurality of light-emitting diode blocks 45 (to be referred to as blocks 45 hereinafter) arranged in the widthwise direction and convey direction of the printing sheet 2 to form a matrix have addresses indicating their positions, as shown in FIG. 2B. More specifically, the address of the block 45 located at the end in the direction of the arrow A and the end in the direction of the arrow C in FIG. 2B is expressed as (1, 1) using a count “M” obtained by counting in the directions of the arrows C and D and a count “N” obtained by counting in the directions of the arrows A and B. The address of the block 45 located at the end in the direction of the arrow B and the end in the direction of the arrow D is expressed as (Mmax, Nmax).

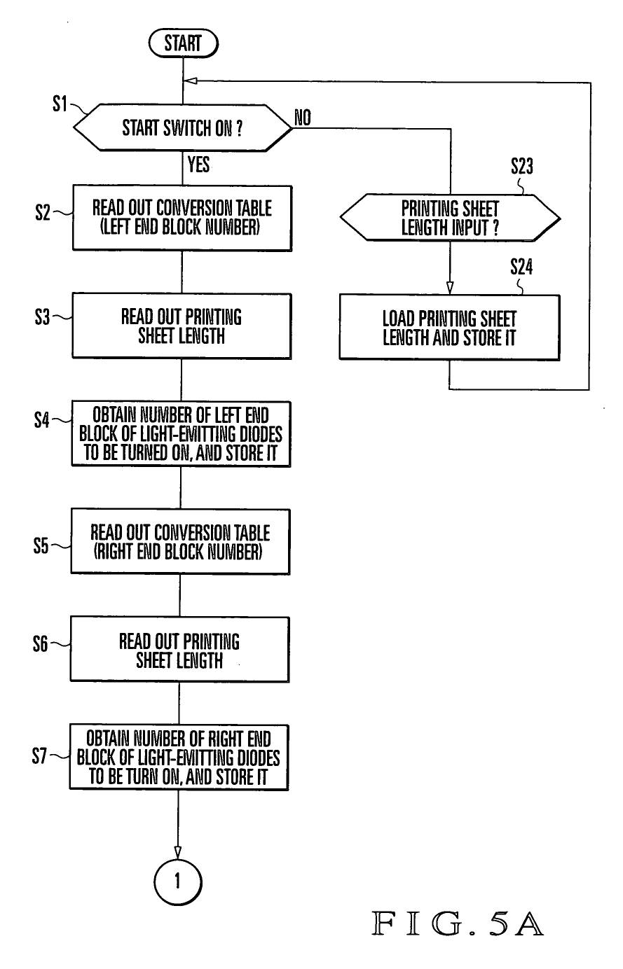

The electrical configuration of the sheet-fed rotary printing press will be described with reference to FIG. 4. The sheet-fed rotary printing press comprises a CPU (Central Processing Unit) 25, a RAM (Random Access Memory) 26, a ROM (Read Only Memory) 27, a start switch 28, an input device 29, a display 30, an output device 31 such as a flexible disk drive, printer, or the like, a setting unit 33, a plurality of light-emitting relays 35, and memories M1 to M9.

The start switch 28 instructs start of sheet size preset operation. The length of the printing sheet 2 in the widthwise direction is set in the setting unit 33. The light-emitting relays 35 enable/disable light emission (power supply) of the light-emitting diodes 22 included in the blocks 45 at the address (1, 1) to the address (Mmax, Nmax). The respective elements 28 to 31, 33, and 35 described above are connected to the CPU 25 via interfaces (I/Os) 32, 34, and 36.

The memory M1 stores the length of the printing sheet 2 in the widthwise direction. The memory M2 stores a conversion table indicating the relationship between “the length of the printing sheet 2 in the widthwise direction and the number of the left end block of the light-emitting diodes 22 to be turned on”. The memory M3 stores the number of the left end block of the light-emitting diodes 22 to be turned on. The memory M4 stores a conversion table indicating the relationship between “the length of the printing sheet 2 in the widthwise direction and the number of the right end block of the light-emitting diodes 22 to be turned on”. The memory M5 stores the number of the right end block of the light-emitting diodes 22 to be turned on.

The memory M6 stores the count “M”. The memory M7 stores the count “N”. The memory M8 stores a total count Nmax of light-emitting diode blocks in the sheet convey direction. The memory M9 stores a total count Mmax of light-emitting diode blocks in the widthwise direction of the printing sheet.

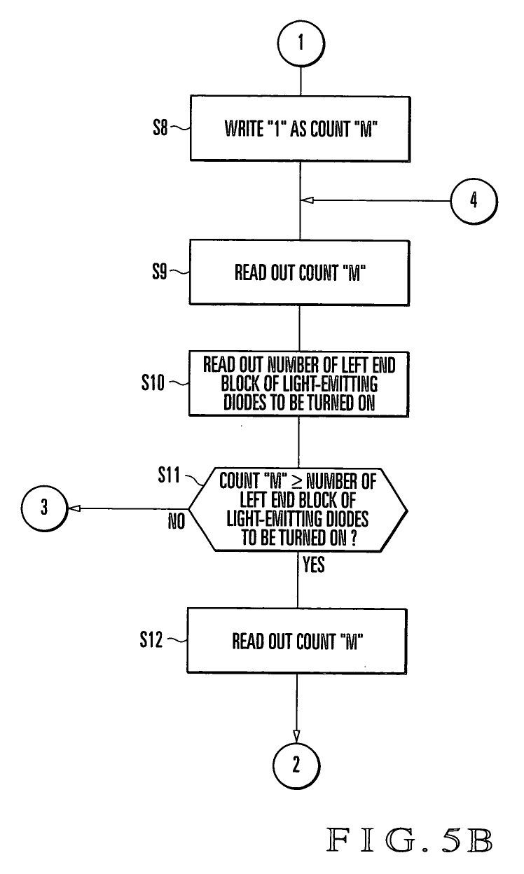

The operation of setting the operation of the drying device in accordance with the printing sheet size will be described with reference to FIGS. 5A to 5C. First, the CPU 25 checks whether or not the start switch 28 is ON (step S1). If the start switch 28 is OFF (NO in step S1), the CPU 25 checks whether or not the width of the printing sheet in the widthwise direction is input to the setting unit 33 (step S23). If YES, the CPU 25 loads the length of the printing sheet in the widthwise direction from the setting unit 33, and stores it in the memory M1.

If the start switch 28 is ON (YES in step S1), the CPU 25 reads out the conversion table indicating the relationship between “the length of the printing sheet 2 in the widthwise direction and the number of the left end block of the light-emitting diodes to be turned on” from the memory M2 (step S2). Then, the CPU 25 reads out the length of the printing sheet 2 in the widthwise direction from the memory M1 (step S3). Using the conversion table read out in step S2, the CPU 25 obtains the number of the left end block of the light-emitting diodes to be turned on from the length of the printing sheet 2 in the widthwise direction, and stores it in the memory M3 (step S4).

The CPU 25 then reads out the conversion table indicating the relationship between “the length of the printing sheet 2 in the widthwise direction and the number of the right end block of the light-emitting diodes to be turned on” from the memory M4 (step S5). Then, the CPU 25 reads out the length of the printing sheet 2 in the widthwise direction from the memory M1 (step S6). Using the conversion table read out in step S5, the CPU 25 obtains the number of the right end block of the light-emitting diodes to be turned on from the length of the printing sheet 2 in the widthwise direction, and stores it in the memory M5 (step S7).

### [Determination of Left End Block of Turn-on Range of Light-Emitting Diodes in Widthwise Direction]

The CPU 25 writes “1” as the count “M” stored in the memory M6 (step S8). The CPU 25 then reads out the count “M” from the memory M6 (step S9). The CPU 25 then reads out the number of the left end block of the light-emitting diodes 22 to be turned on from the memory M3 (step S10). Then, the CPU 25 checks whether or not the count “M” is equal to or more than the number of the left end block of the light-emitting diodes 22 to be turned on (step S11).

If the count “M” is less than the block number (NO in step S11), the CPU 25 increments the count “M” of the memory M6 by one and stores it by overwrite (step S20). The CPU 25 then reads out the total count Mmax of light-emitting diode blocks in the widthwise direction from the memory M9 (step S21). The CPU 25 then checks whether or not the count “M” is equal to or more than the total count Mmax of light-emitting diode blocks (step S22). If NO, the process returns to step S9.

The process of steps S9 to S11 and S20 to S22 described above is repeated until the count “M” becomes equal to the number of the left end block of the light-emitting diodes 22 to be turned on in step S11. If the count “M” becomes equal to the number of the left end block of the light-emitting diodes 22 to be turned on (YES in step S11), the left end block of the turn-on range of the light-emitting-diodes is determined.

### [Determination of Right End Block of Turn-on Range of Light-Emitting Diodes in Widthwise Direction]

After the left end of the turn-on range of the light-emitting diodes is determined, the CPU 25 reads out the count “M” stored in the memory M6 (step S12). The CPU 25 then reads out the number of the right end block of the light-emitting diodes 22 to be turned on from the memory M5 (step S13). The CPU 25 then checks whether or not the count “M” is equal to or more than the number of the right end block of the light-emitting diodes 22 to be turned on (step S14).

If the count “M” is equal to or more than the block number (YES in step S14), the CPU 25 increments the count “M” of the memory M6 by one and stores it by overwrite (step S20). The CPU 25 then reads out the total count Mmax of light-emitting diode blocks in the widthwise direction from the memory M9 (step S21). The CPU 25 then checks whether or not the count “M” is equal to or more than the total count Mmax of light-emitting diode blocks (step S22). If the count “M” is less than the total block count Mmax (NO in step S22), the process returns to step S9.

The process of steps S9 to S14 and S20 to S22 described above is repeated until the count “M” becomes equal to the number of the left end block of the light-emitting diodes 22 to be turned on in step S14. If the count “M” becomes equal to the number of the right end block of the light-emitting diodes 22 to be turned on, the right end block of the turn-on range of the light-emitting diodes 22 is determined.

### [Sequential Lighting of Light-Emitting Diodes in Sheet Convey Direction]

After the right end block of the turn-on range of the light-emitting diodes 22 is determined, the CPU 25 writes “1” as the count “IN” stored in the memory M7 (step S15). The CPU 25 then turns on the light-emitting relay 35 included in the block which is the “M”th from the left end and the “N”th from the most upstream side in the sheet convey direction (step S16). The CPU 25 then increments the count “N” stored in the memory M7 by one and stores it by overwrite (step S17).

The CPU 25 then reads out the total count Nmax of light-emitting diode blocks in the sheet convey direction from the memory M8 (step S18). The CPU 25 then checks whether or not the count “N” is equal to or more than the total count Nmax of light-emitting block diodes in the sheet convey direction (step S19). If NO in step S19, the process returns to step S16.

The process of steps S16 to S19 is repeated until the count “N” becomes larger than the total count Nmax of light-emitting diode blocks in the sheet convey direction in step S19. If the count “N” becomes larger than the total count Nmax of light-emitting diode blocks in the sheet convey direction (YES in step S19), power is supplied to the light-emitting diodes in the entire range of the widthwise direction corresponding to the length of the printing sheet in the widthwise direction and the entire range of the sheet convey direction, thereby turning on these light-emitting diodes.

Then, the CPU 25 increments the count “M” stored in the memory M6 by one and stores it by overwrite (step S20). The CPU 25 then reads out the total count Mmax of light-emitting diode blocks in the widthwise direction from the memory M8 (step S21). If the count “M” is larger than the total count Mmax of light-emitting diode blocks in the widthwise direction, the CPU 25 stops operation (step S22).

In this embodiment, the light-emitting diodes 22 are blocked in the widthwise direction and convey direction of the printing sheet 2. Blocks are selected in accordance with the sheet size only in the widthwise direction of the printing sheet 2, and all the blocks in the convey direction of the printing sheet 2 are selected. The blocks can naturally be selected in accordance with the sheet size in both the widthwise direction and convey direction of the printing sheet 2. In this case, the block number at the lower end of the printing sheet 2 in the convey direction may be compared with the incremented block number, and blocks with block numbers that coincide with incremented block numbers may be selected. The blocks may naturally be selected in accordance with the sheet size only in the convey direction of the printing sheet 2.

According to this embodiment, since the drying device 6 employs only the light-emitting diodes 22 that emit ultraviolet rays, deformation of the printing product by heat does not occur. No space need be ensured to install a cooling device, thus decreasing the space and the manufacturing cost. Since the ultraviolet ray generation efficiency of the light-emitting diodes 22 can be increased, small power will do for the light-emitting diodes 22, so that power saving can be achieved.

Since ultraviolet rays from the plurality of light-emitting diodes 22 arranged in a matrix can irradiate the entire printing sheet comparatively evenly, drying nonuniformity does not occur. Since the blocks to which power is to be supplied can be selected in accordance with the size of the printing sheet in the widthwise direction, power saving can be achieved.

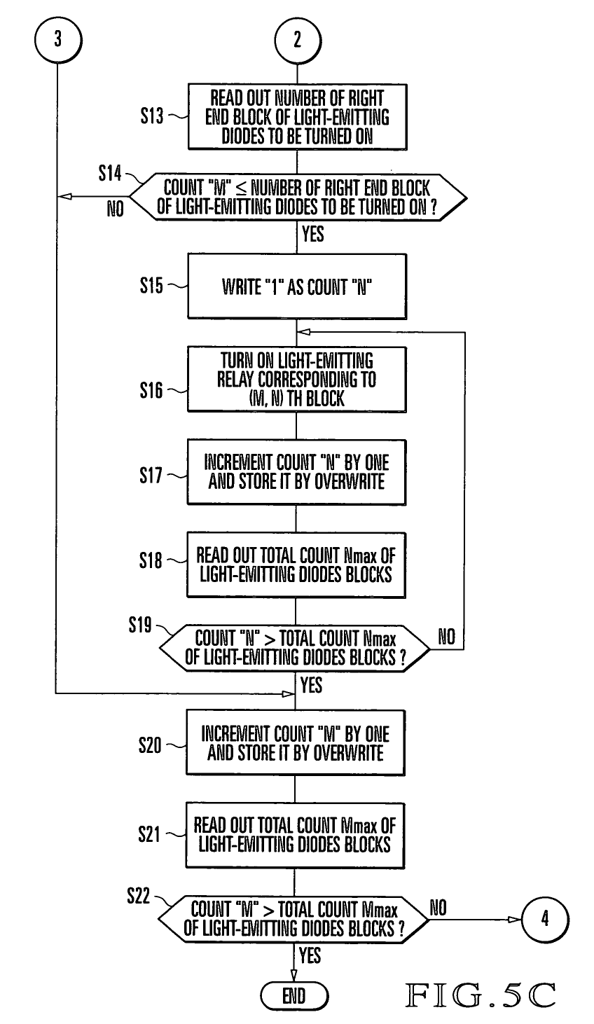

The second embodiment of the present invention will be described with reference to FIG. 6. In a sheet-fed rotary printing press 101 according to this embodiment, drying devices 6 are arranged close to the outer circumferential surfaces of impression cylinders 10 of printing units 4A to 4D, respectively. A perforating device 30 has an impression cylinder 31 and perforation tooth cylinder 32. According to this embodiment, the same operation and effect as those of the first embodiment can be obtained.

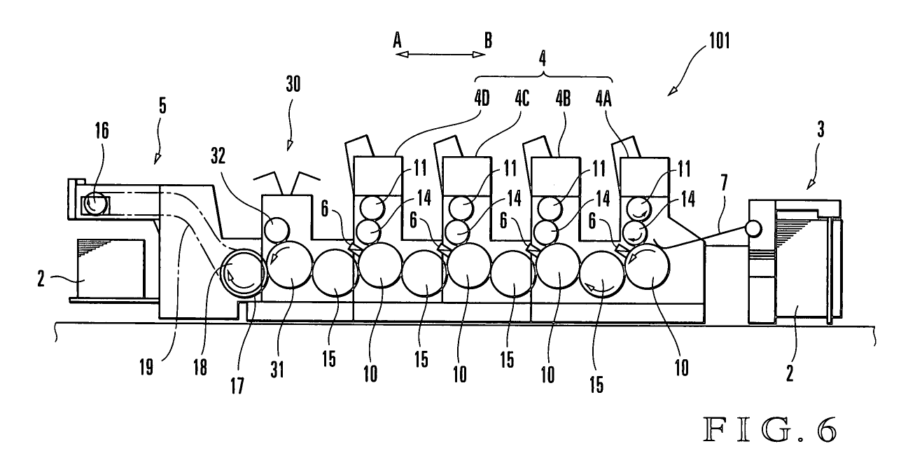

The third embodiment of the present invention will be described with reference to FIG. 7. In a sheet-fed rotary printing press 201 according to this embodiment, a varnish coating device 40 is disposed between a printing unit 4 and delivery device 5. A drying device 6 is arranged to sandwich convey-side delivery chains 19 from above and below. The varnish coating device 40 comprises an obverse varnish coating unit 41 which coats the obverse of a printing sheet 2 with UV varnish as a liquid, a reverse varnish coating unit 42 which coats the reverse of the printing sheet 2 with the UV varnish, and an impression cylinder 43 which receives the printing sheet from a printing unit 4D through a transfer cylinder 15 and transfers the printing sheet to the delivery device 5. The obverse varnish coating unit 41 and reverse varnish coating unit 42 coat the obverse and reverse of the printing sheet 2, gripping-changed and conveyed from the grippers of the transfer cylinder 15 to the grippers of the reverse varnish coating unit 54, with the UV varnish as the liquid.

In this arrangement, the UV ink printed by the printing unit 4 and the UV varnish coated by the varnish coating device 40 are dried while the delivery chains 19 convey the printing sheet 2. According to this embodiment, the same operation and effect as those of the first and second embodiments can be obtained.

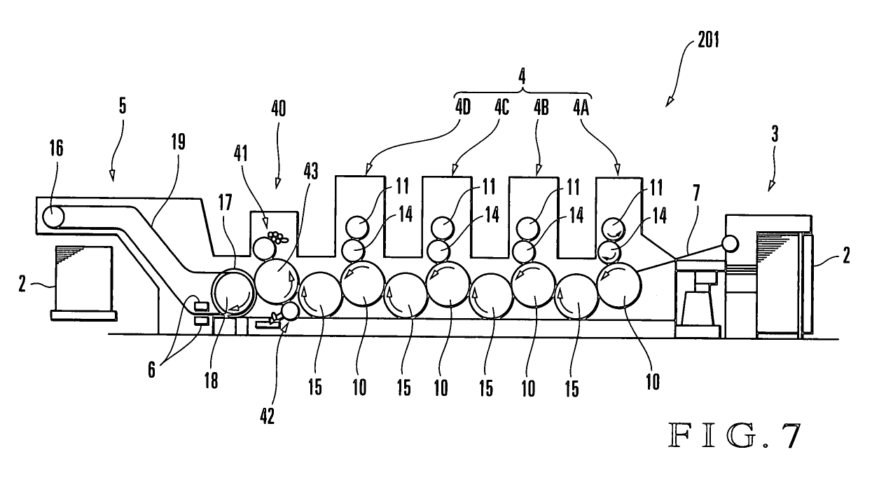

The fourth embodiment of the present invention will be described with reference to FIG. 8. A sheet-fed rotary printing press 301 according to this embodiment comprises a feed device 3, an obverse printing unit 50, a reverse printing unit 51, two sets of obverse varnish coating units 52 and 53, two sets of reverse varnish coating units 54 and 55, and a delivery device 5. Each of the obverse printing unit 50 and reverse printing unit 51 comprises a plate cylinder 56, blanket cylinder 57, and impression cylinder 58. Each of the obverse varnish coating units 52 and 53 and reverse varnish coating units 54 and 55 comprises a chamber coater 59, anilox roller 60, blanket cylinder 61, and impression cylinder 62. A plurality of drying devices 6 are arranged close to the surfaces of the impression cylinders 58 of the obverse printing unit 50 and reverse printing unit 51, the impression cylinders 62 of the obverse varnish coating units 52 and 53 and reverse varnish coating units 54 and 55, and the transport cylinders 63 and 64, respectively.

In this arrangement, each of printing sheets 2 which are fed from the feed device 3 to a feeder board 7 one by one is gripping-changed and conveyed from a swing arm shaft pregripper 9 to the grippers of the impression cylinder 58 of the obverse printing unit 50 through a transfer cylinder 65. At this time, the obverse of the printing sheet 2 is printed, and the corresponding drying device 6 dries the printed UV ink. While the printing sheet 2 is being gripping-changed to and conveyed by the grippers of the impression cylinder 58 of the reverse printing unit 51, its reverse is printed, and the corresponding drying device 6 dries the printed UV ink.

The obverse varnish coating units 52 and 53 coat the obverse of the sheet 2 with the UV varnish as the liquid, and the corresponding drying devices 6 dry the UV varnish. The reverse varnish coating units 54 and 55 coat the reverse of the sheet 2 with the UV varnish, and the corresponding drying devices 6 dry the UV varnish.

After that, while the transport cylinder 63 conveys the sheet 2, the corresponding drying devices 6 dry the UV ink and UV varnish transferred to the obverse of the sheet 2. Then, while the transport cylinder 64 conveys the sheet 2, the corresponding drying devices 6 dry the UV ink and UV varnish transferred to the reverse of the sheet 2. Then, the sheet 2 is delivered to the delivery device 5 through a transfer cylinder 66. According to this embodiment, the same operation and effect as those of the first to third embodiments can be obtained.

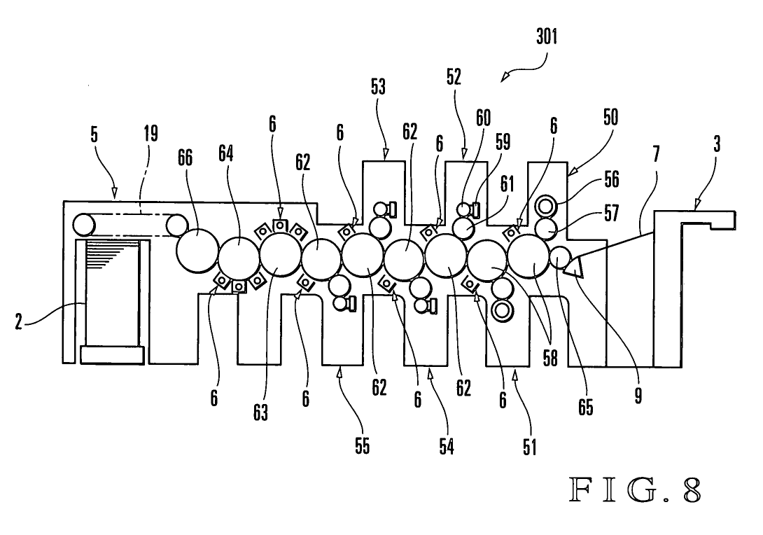

A fifth embodiment of the present invention will be described with reference to FIG. 9. A cold stamping device 401 comprises a transfer device 70 which transfers an adhesive pattern representing an image onto a printing sheet, and a covering device 71 which urges a transfer foil against the printing sheet to transfer it. The adhesive pattern is formed of an ultraviolet curing adhesive as a liquid. The covering device 71 comprises a press roller 72, a countercylinder 73 which opposes the press roller 72, a transfer slit 74 formed between the press roller 72 and countercylinder 73, a foil storage roll 76 which supplies a transfer foil 75 to the transfer slit 74, and a foil collection roll 77 which collects the used transfer foil. Drying devices 6 are arranged close to the surface of a countercylinder 78 of the transfer device 70 and the surface of the countercylinder 73 of the covering device 71, respectively.

In this arrangement, while the countercylinder 78 conveys the printing sheet, the corresponding drying device 6 dries the adhesive pattern transferred to the printing sheet by the transfer device 70. Then, a transport device 79 gripping-changes the printed sheet to the grippers of the countercylinder 73. As the printed sheet gripping-changed to the grippers of the countercylinder 73 passes between the press roller 72 and countercylinder 73, the transfer foil 75 is transferred to the adhesive pattern through the transfer slit 74. Then, while the countercylinder 73 conveys the printed sheet, the corresponding drying device 6 dries the adhesive pattern to which the transfer foil 75 has been transferred. In this embodiment, the same operation and effect as those of the first to fourth embodiments can be obtained.

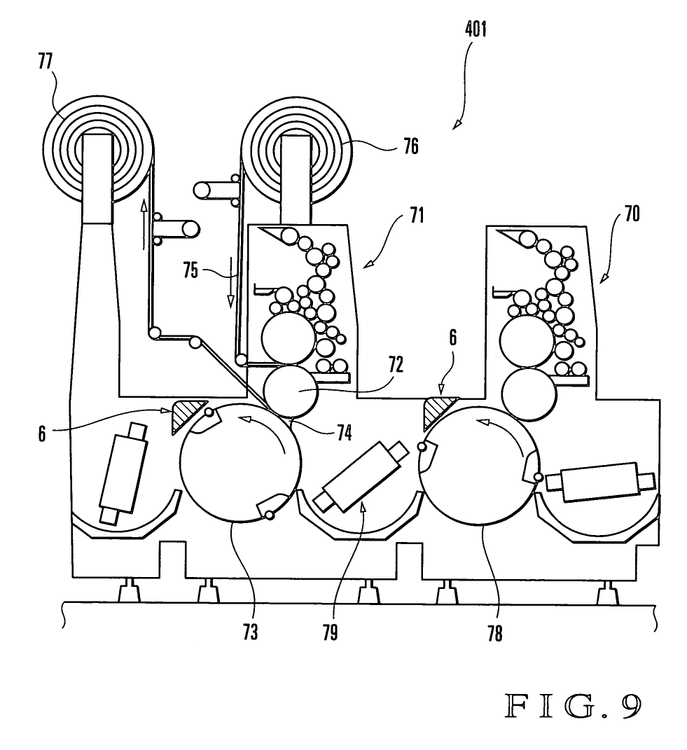

The first modification of the drying device shown in FIG. 2A will be descried with reference to FIG. 10. In the first modification, the light-emitting diodes 22 are positioned such that gaps L among the light-emitting diodes 22 adjacent to each other in the widthwise direction and sheet convey direction of the printing sheet 2 are the same. More specifically, the light-emitting diodes 22 are arranged in a large number equidistantly in the widthwise direction (the directions of the arrows C and D) of the printing sheet 2 and in a staggered manner in the sheet convey direction (the directions of the arrows A and B).

According to this modification, the gaps L among the light-emitting diodes 22 adjacent to each other in the widthwise direction and sheet convey direction of the printing sheet 2 are set to be the same. Therefore, ultraviolet rays emitted from the large number of light-emitting diodes 22 irradiate the entire printing sheet 2 comparatively evenly, so that drying nonuniformity does not occur. In this modification, the light-emitting diodes 22 are divided into three blocks 23A, 23B, and 23C, each of which is formed in a staggered manner in the convey direction of the printing sheet 2, to match the size of the printing sheet 2 in the widthwise direction, in the same manner as in the first embodiment. Therefore, the light-emitting diodes 22 can be selectively turned on in accordance with the size of the printing sheet in the widthwise direction.

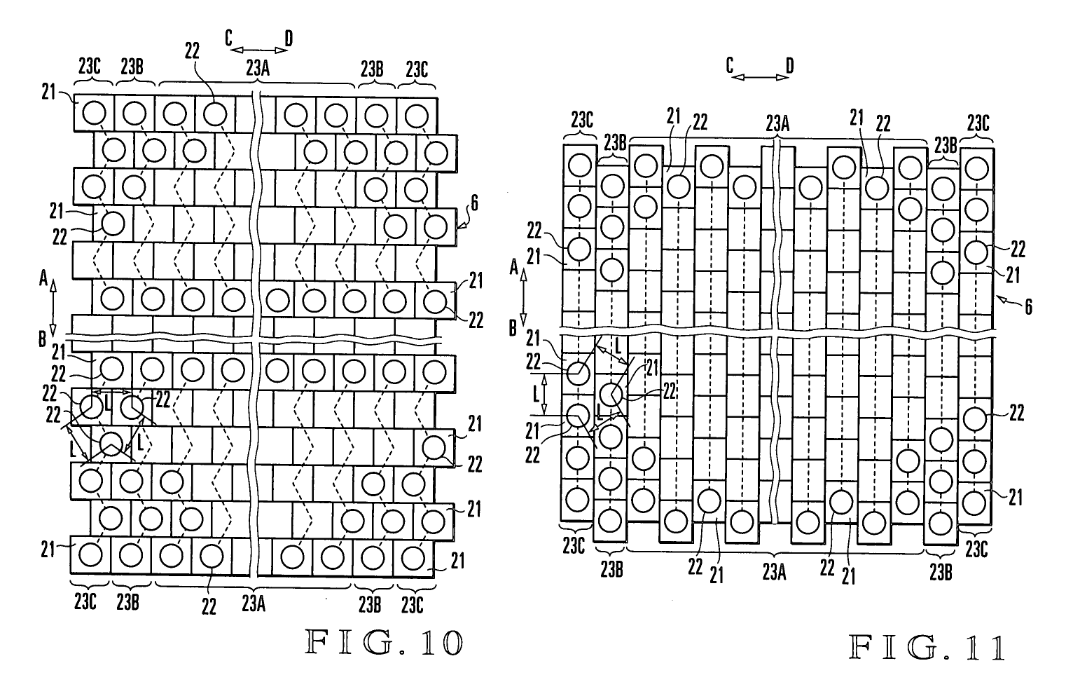

The second modification of the drying device shown in FIG. 2A will be described with reference to FIG. 11. In this modification, the light-emitting diodes 22 are positioned such that the gaps L among the light-emitting diodes 22 adjacent to each other in the widthwise direction and convey direction of the printing sheet 2 are the same. More specifically, the light-emitting diodes 22 are arranged in a large number equidistantly in the sheet convey direction (the directions of the arrows A and B) and in a staggered manner in the widthwise direction (the directions of the arrows C and D).

According to this modification, the gaps L among the light-emitting diodes 22 adjacent to each other in the widthwise direction and sheet convey direction of the printing sheet 2 are set to be the same. Therefore, ultraviolet rays emitted from the large number of light-emitting diodes 22 irradiate the entire printing sheet 2 comparatively evenly, so that drying nonuniformity does not occur. In this modification, the light-emitting diodes 22 are divided into three blocks 23A, 23B, and 23C to match the size of the printing sheet 2 in the widthwise direction, in the same manner as in the first embodiment. Therefore, the light-emitting diodes 22 can be selectively turned on in accordance with the size of the printing sheet in the widthwise direction.

The embodiments described above exemplify a sheet-fed rotary printing press which prints a sheet.

The present invention can also be applied to a rotary printing press which prints a web.

As has been described above, according to the present invention, deformation of the printing product by heat produced by infrared rays does not occur. No space need be ensured to install a cooling device, thus decreasing the space and the manufacturing cost. Small power will do for the ultraviolet-emitting diodes, so that power saving can be achieved.

What is claimed is:

1. A liquid curing apparatus for a liquid transfer device, comprising:
a liquid transfer unit which transfers an ultraviolet curing liquid to a transfer target body; and
a plurality of ultraviolet-emitting diodes which are arranged to oppose the transfer target body and emit only ultraviolet-wavelength light to irradiate the transfer target body to which the liquid has been transferred by said liquid transfer unit, thereby curing the transferred liquid.

2. An apparatus according to claim 1, wherein
the liquid comprises ultraviolet curing ink, and
said liquid transfer device comprises a printing press.

3. An apparatus according to claim 1, wherein
the liquid comprises ultraviolet curing varnish, and
said liquid transfer device comprises a varnish coating unit.

4. An apparatus according to claim 1, wherein
the liquid comprises an ultraviolet curing adhesive, and
said liquid transfer device comprises an adhesive transfer unit.

5. An apparatus according to claim 1, wherein said plurality of ultraviolet-emitting diodes are arranged in a widthwise direction and a convey direction of the transfer target body to form a matrix.

6. An apparatus according to claim 5, wherein said plurality of ultraviolet-emitting diodes are divided into a plurality of blocks, and power is supplied to said plurality of ultraviolet-emitting diodes which correspond to respective ones of said blocks.

7. An apparatus according to claim 6, wherein
said plurality of ultraviolet-emitting diodes are divided in the widthwise direction of the transfer target body to form a plurality of blocks, and
power is supplied to said plurality of ultraviolet-emitting diodes included in at least one of said blocks that corresponds to a width of the transfer target body.

8. An apparatus according to claim 1, wherein said plurality of ultraviolet-emitting diodes are arranged equidistantly in a widthwise direction of the transfer target body and in a staggered manner in a convey direction of the transfer target body.

9. An apparatus according to claim 8, wherein said plurality of ultraviolet-emitting diodes are divided into a plurality of blocks, and power is supplied to said plurality of ultraviolet-emitting diodes which correspond to respective ones of said blocks.

10. An apparatus according to claim 9, wherein
said plurality of ultraviolet-emitting diodes are divided into a plurality of blocks in the widthwise direction of the transfer target body, and
power is supplied to said plurality of ultraviolet-emitting diodes included in a block corresponding to a length of the transfer target body in the widthwise direction.

11. An apparatus according to claim 1, wherein said ultraviolet-emitting diodes are arranged equidistantly in a convey direction of the transfer target body and in a staggered manner in a widthwise direction of the transfer target body.

12. An apparatus according to claim 11, wherein said plurality of ultraviolet-emitting diodes are divided into a plurality of blocks, and power is supplied to said plurality of ultraviolet-emitting diodes which correspond to respective ones of said blocks.

13. An apparatus according to claim 12, wherein
said plurality of ultraviolet-emitting diodes are divided into a plurality of blocks in the widthwise direction of the transfer target body, and
power is supplied to said plurality of ultraviolet-emitting diodes included in a block corresponding to a length of the transfer target body in the widthwise direction.

14. An apparatus according to claim 1, further comprising
a setting unit in which a length of the transfer target body in a widthwise direction is set,
a first memory which stores a conversion table representing a relationship between the length of the transfer target body in the widthwise direction and a number of a left end block of said ultraviolet-emitting diodes that are to be turned on,
a second memory which stores a conversion table representing a relationship between the length of the transfer target body in the widthwise direction and a number of a right end block of said ultraviolet-emitting diodes that are to be turned on, and
a control unit which looks up said conversion tables respectively stored in said first memory and said second memory on the basis of the length of the transfer target body set in said setting unit to determine the number of the left end block and the number of the right end block of said ultraviolet-emitting diodes that are to be turned on.

15. An apparatus according to claim 14, wherein
said plurality of ultraviolet-emitting diodes are divided into a plurality of blocks in the widthwise direction of the transfer target body, and
said control unit supplies power to said ultraviolet-emitting diodes included in two side blocks corresponding to the determined block numbers and an inner block sandwiched by said two side blocks.
